(19) United States
(12) Patent Application Publication
(10) Pub. No.: US 2013/0254022 A1
(43) Pub. Date: Sep. 26, 2013

(54) Method and System for Multimedia Content Stream and Social Network for Locations

(71) Applicant: Shaun Rubrecht, St. Petersburg, FL (US)

(72) Inventor: Shaun Rubrecht, St. Petersburg, FL (US)

(21) Appl. No.: 13/762,557

(22) Filed: Feb. 8, 2013

Related U.S. Application Data
(60) Provisional application No. 61/596,572, filed on Feb. 8, 2012.

(51) Int. Cl. G06Q 30/02

(52) U.S. Cl. CPC G06Q 30/0261
USPC 705/14.48; 705/14.58

(57) ABSTRACT

A system and method for preparing an advertising campaign, the campaign prepared on a first mobile device and directed to a demographic group within a location. The campaign is then received by a second mobile device associated with the demographic group when the second mobile device is located within the location. The system can be accessed through a website or through mobile platform applications. Certain content can only be added through a mobile device in which GPS data and photo time stamping will be accessed. Real-time content will be viewable by users in the form of a two-directional stream of photos with related comments in which this content is prioritized by time and algorithmic methods. Users will have the ability to communicate with other users through the system while advertising can be set up in the mobile application with payment occurring through an in-app purchasing mechanism.

### BACKGROUND OF THE INVENTION

1. Field of the Invention

This invention relates to real-time streaming of multimedia content between locations and people.

2. Description of the Background Art

Presently, various social networks exist that allow an exchange of real-time information between people. There are, however, shortcomings involving real-time content streaming involving nodes between locations and people within the social networking framework. A location is not a living entity and therefore requires people to upload content on its behalf. Although the “Facebook” social network allows people to create “Pages” which may correspond to locations, the content that will display under the “Newsfeed” for the “Friends” of the Page will only display the content provided by the Page creator. Additionally, uploads by others will not display in the Newsfeed and that content can only be found by navigating to the page directly. If a person were interested in many locations, then each page would have to be pulled-up and searched for new content.

Unlike Facebook, the social media “Foursquare” allows anyone to add content to a location without giving content preference to the location's creator. In Foursquare, although any user can add content, this content is not viewable in any feed or stream. If one wanted to see real-time content, then each individual location would need to be searched for new content. Also, Foursquare does not require “friending” of locations to view content.

A shortcoming found in many location-based social networks involves duplicate locations. Facebook and Foursquare face this challenge since any user can create a location but there is not an efficient way for users to delete locations. In some social networks, locations can be deleted by any user but there is no validation process other than reiterating the deletion request.

Generally, the disclosure benefits by combining the “Newsfeed” element from Facebook and the non-preference of content similar to Foursquare. Additionally, systems and methods in accordance with the present disclosure do not require any “friending” to view location information. Since anyone can provide content, the invention requires a photo to be added along with comments, as comments can be subjective while a photo is more objective.

Therefore, it is an object of this invention to provide an improvement which overcomes the aforementioned inadequacies of the prior art devices and provides an improvement which is a significant contribution to the advancement of the multimedia streaming art.

Another object of this invention is to provide a user of any social media site the ability to post multi-media information about a location, which will be viewable by any other user within a real-time photo stream navigable in horizontal and vertical direction.

Another of this object is that a photo stream will prioritize content by algorithmic and time elements.

Another object of this invention is to utilize photo tags such as timestamp and GPS coordinates to validate pictures that are uploaded to the stream.

Another object of this invention is to allow any user to create or delete a venue, while deletions will rely on a new method of validation.

Another object of this invention is to allow advertisers to create campaigns within the system and pay for the advertisements through in-app purchasing.

Another object of this invention is to allow advertisers to create campaigns that are geographically targeted to users who are within the set geographic parameters.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purposes of summarizing this invention, the invention comprises a multi-platform mobile application and website acting as a vehicle for the exchange of location relevant information. Users of the application can post content which includes a photo and a related comment. This content is then viewable by other users in the form of a bi-directional visual stream of the photos with related comments. Users can scroll through this photo stream by navigating horizontally, which will display photos related to different location. By scrolling vertically, users can view all posts related to a single location. Other display mechanisms may also be utilized.

The invention may solve the problem of finding the newest and most relevant location related content via the real-time photo stream. In a preferred embodiment, since any user can post information, photos are required unlike other applications. Furthermore, people do not search locations for the relevant content as they can simply view and navigate the stream. Other applications may have user-provided content, however this content does not display publically without the user selecting each location independently and looking to see if there is any new content to view.

Employing a method of user-initiated deletion verified by group inaction solves the problem of duplicated locations. Other applications that allow users to add locations to the application's database face the problem of duplicate locations, i.e. the same location listed many times generally spelled differently. The deletion tag within the invention solves this problem by allowing a deletion tag to be applied to a location by any user of the application and then deletion occurs after a period of time and inactivity for that location.

The in-app purchasing mechanism available by several of the mobile platform providers is utilized within the application as a revenue stream. Users can customize an advertising campaign that will display at the bottom of the photo stream. Since users are viewing content related to locations, advertisers will benefit by providing content that is also related to locations. Since the advertising content is in-line with the content in the stream, the advertising is less intrusive. Additionally, users can choose a geographic area for the advertisements to display. Only people using the application within the specified geographic area will see the advertisement. Other demographic information is available for targeting within the campaign as well.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is an application flow schematic in accordance with the present disclosure;

FIGS. 2-30 illustrate various embodiments of numerous screens that may be displayed in accordance with the present disclosure. FIGS. 2-30 illustrate the screens in connection with one preferred embodiment, namely a mobile device.

FIG. 31 is a flow chart depicting steps for a location editing method in accordance with the present disclosure.

Similar reference characters refer to similar parts throughout the several views of the drawings.

### DETAILED DESCRIPTION OF THE PREFERRED EMBODIMENT

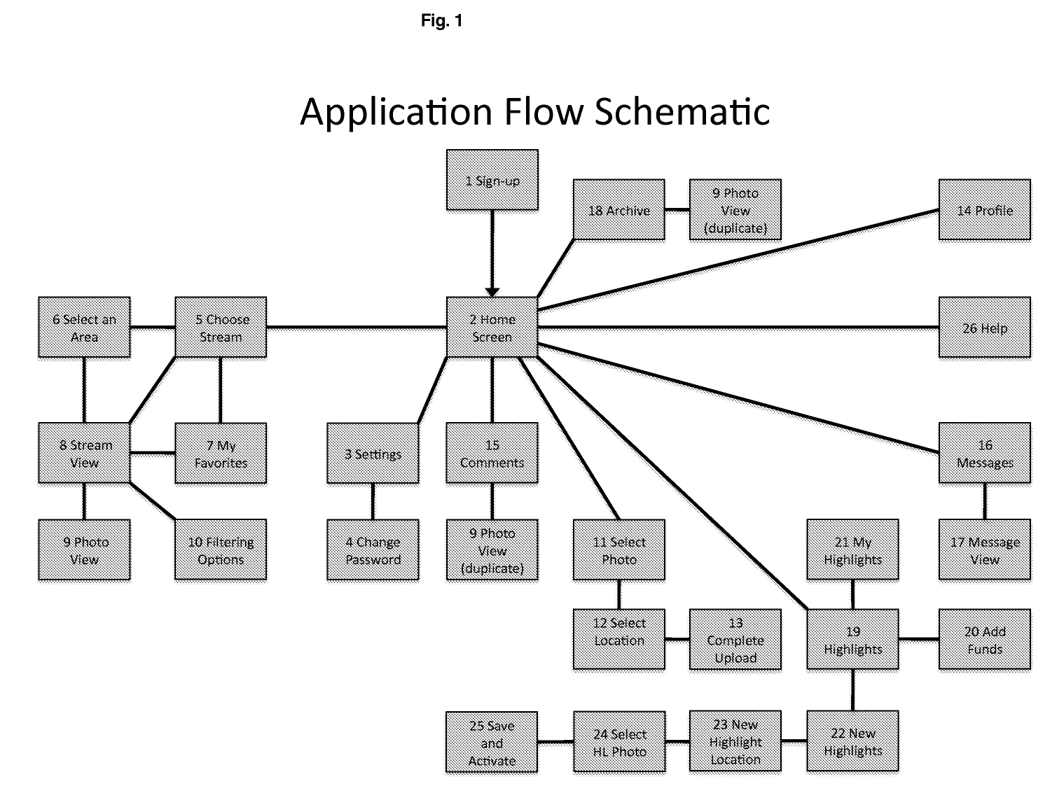

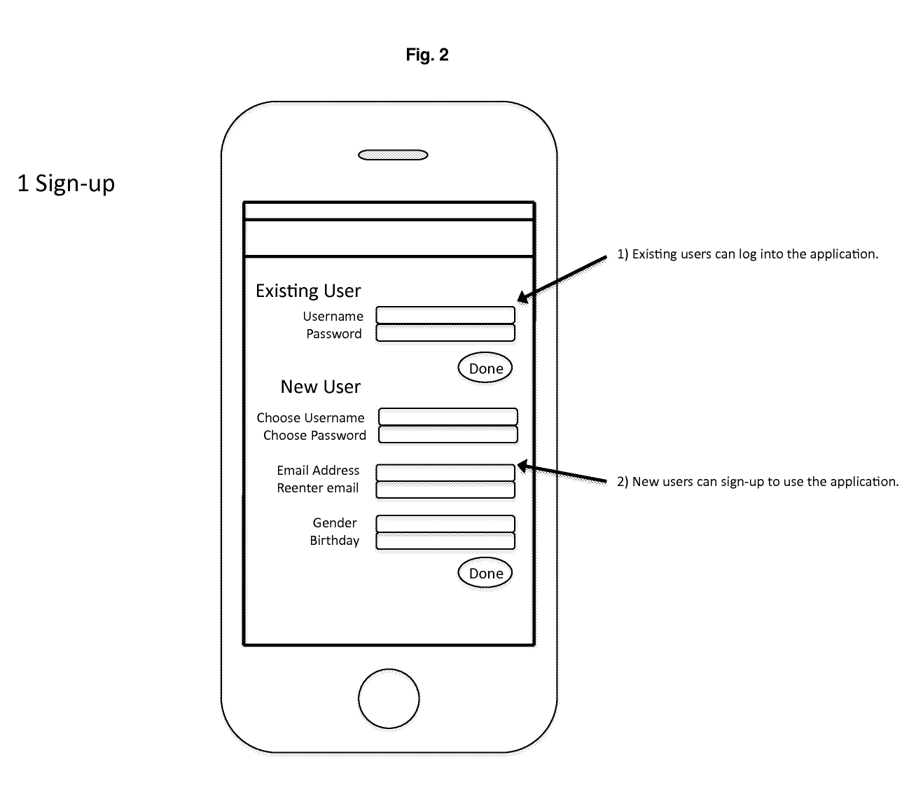

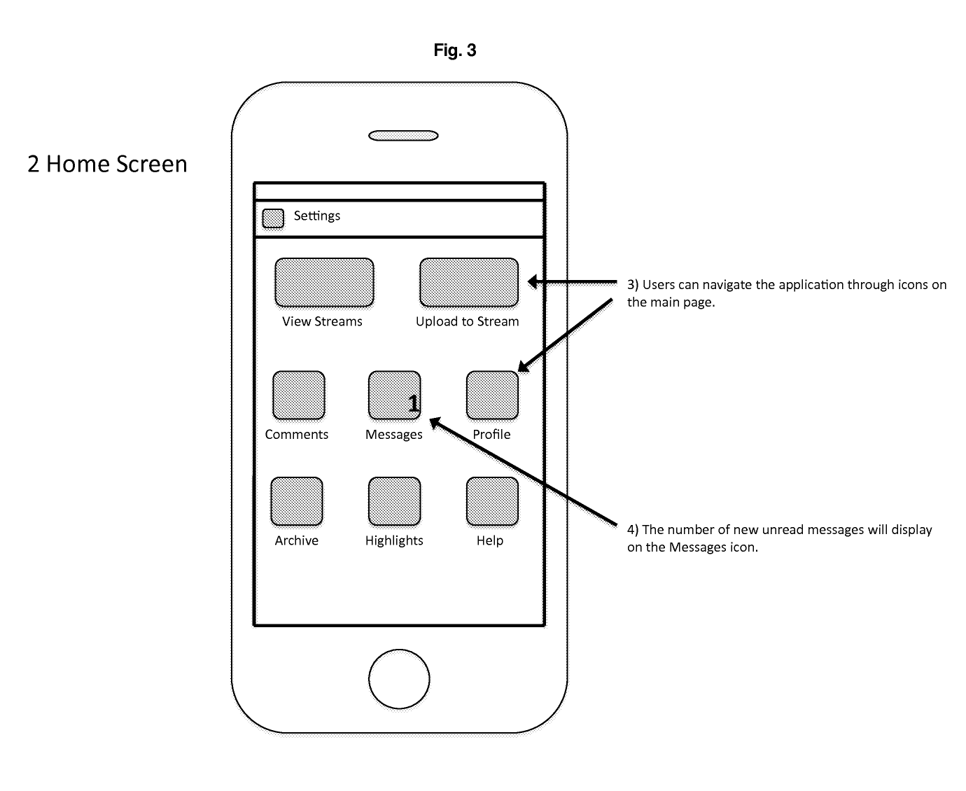

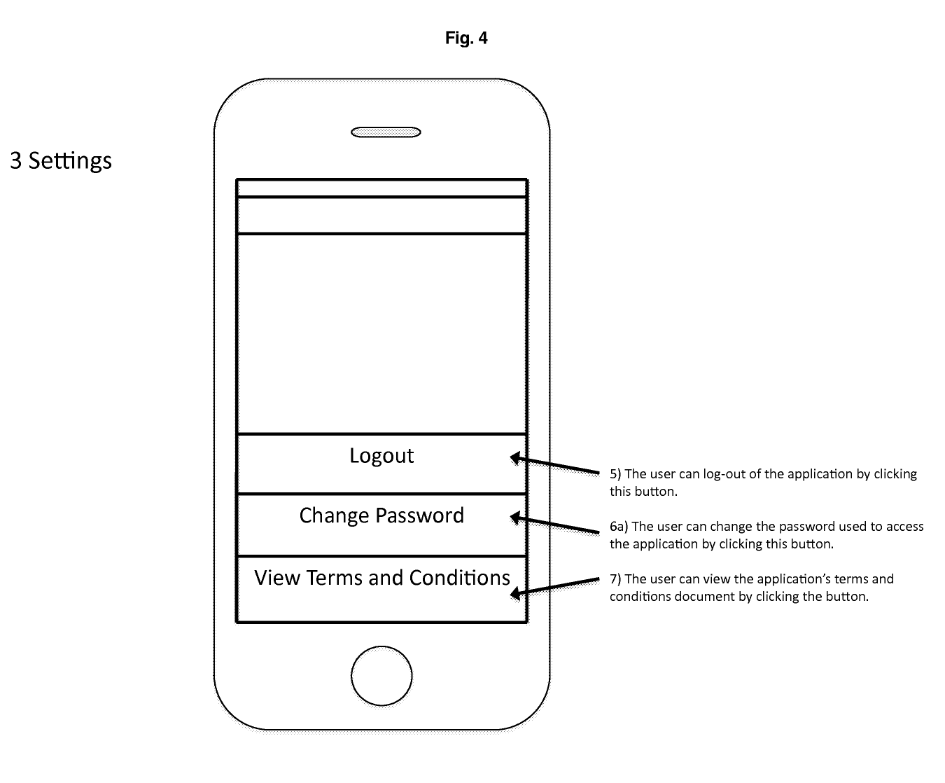

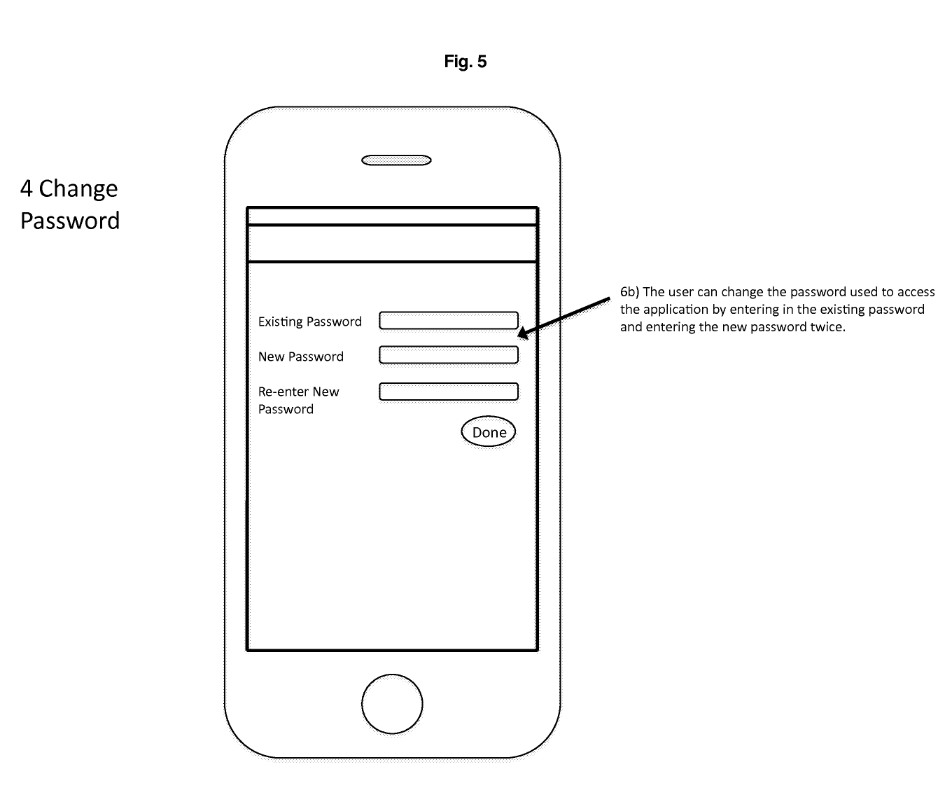

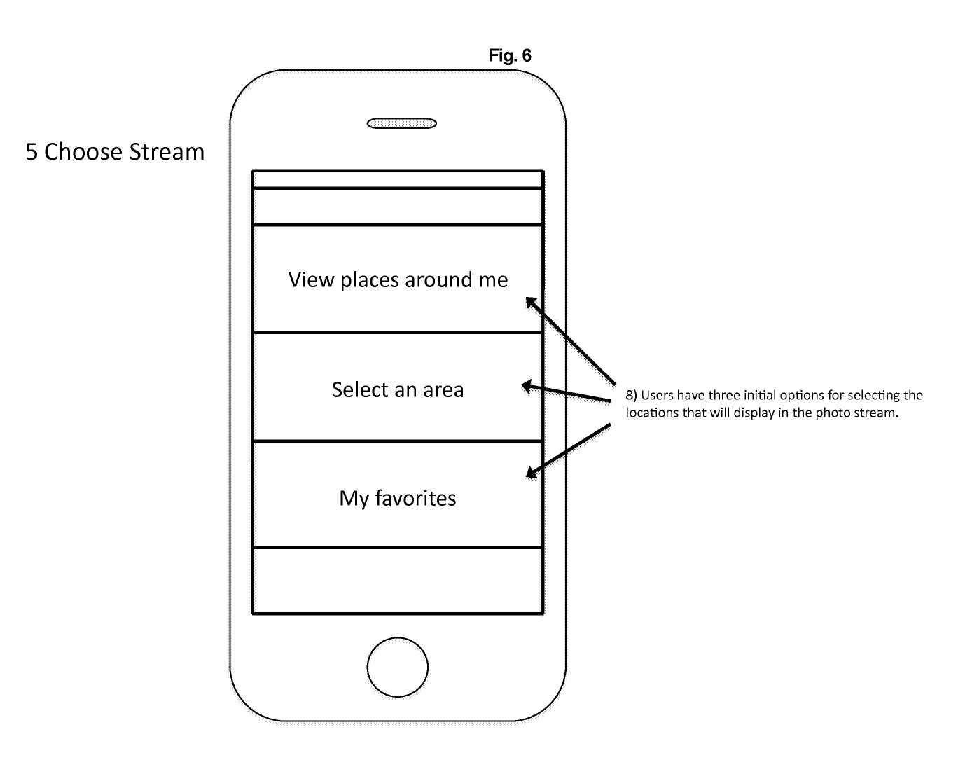

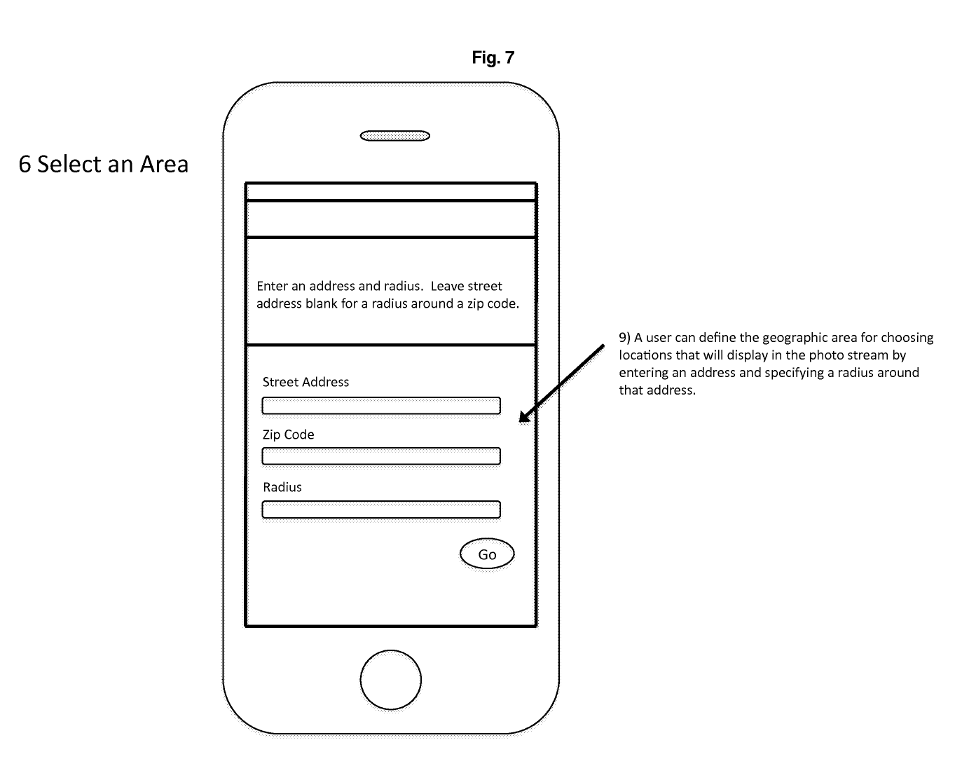

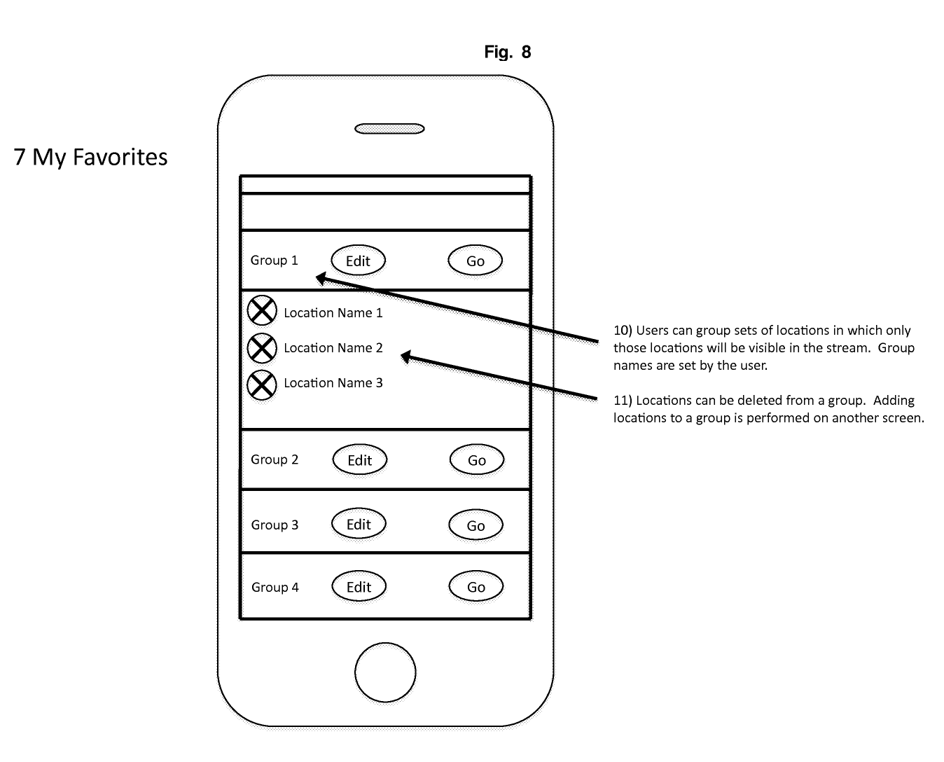

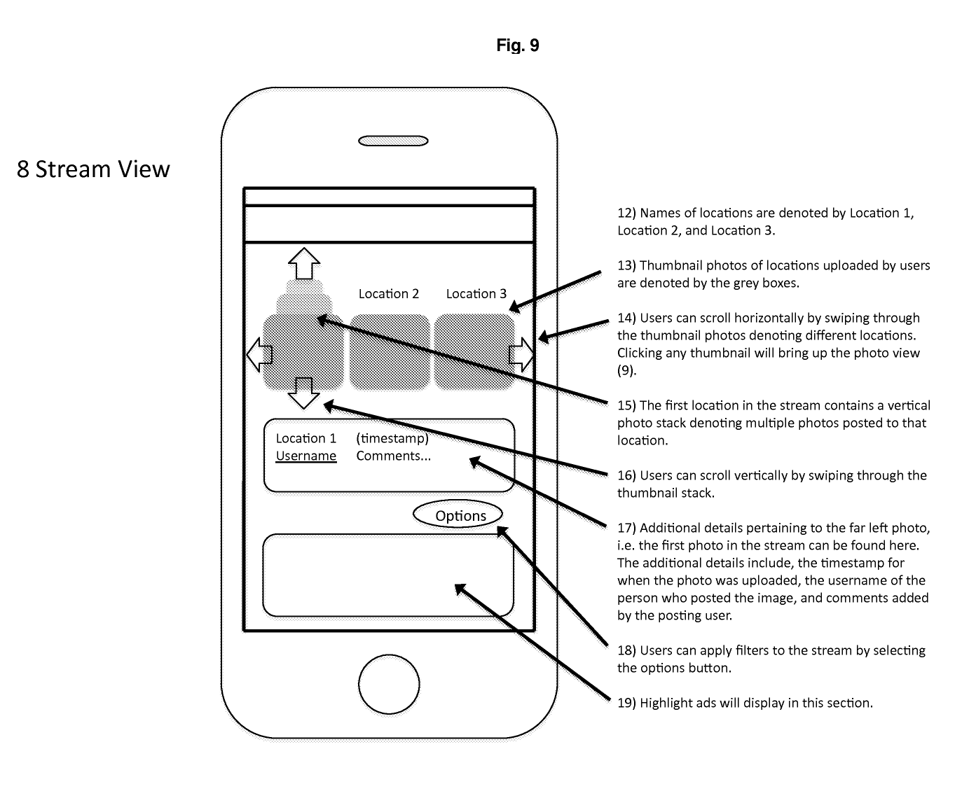

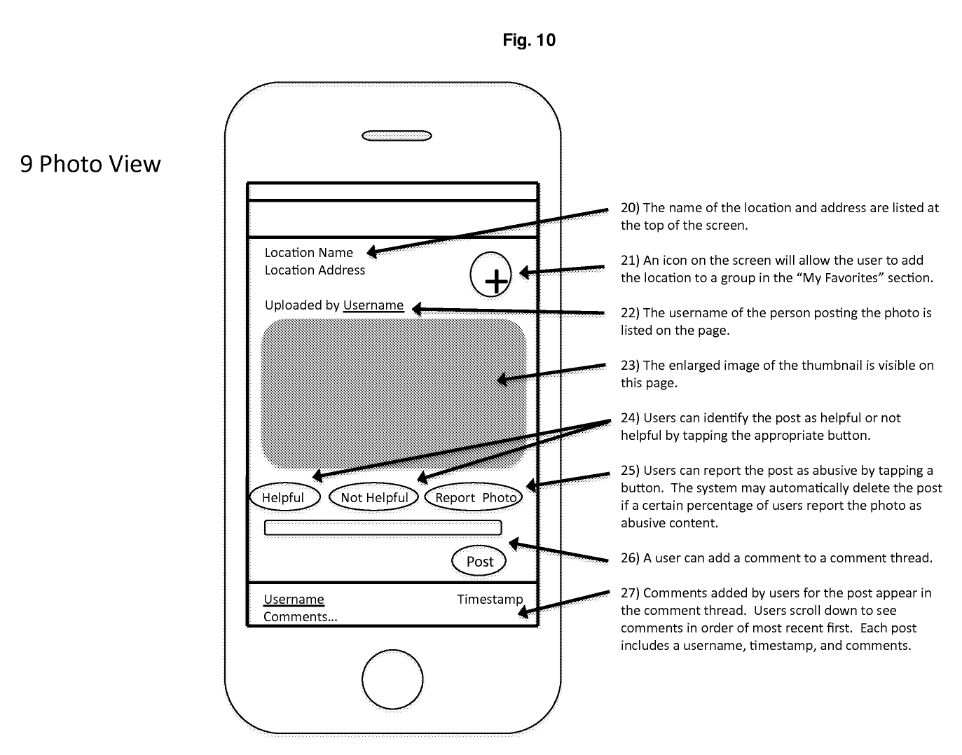

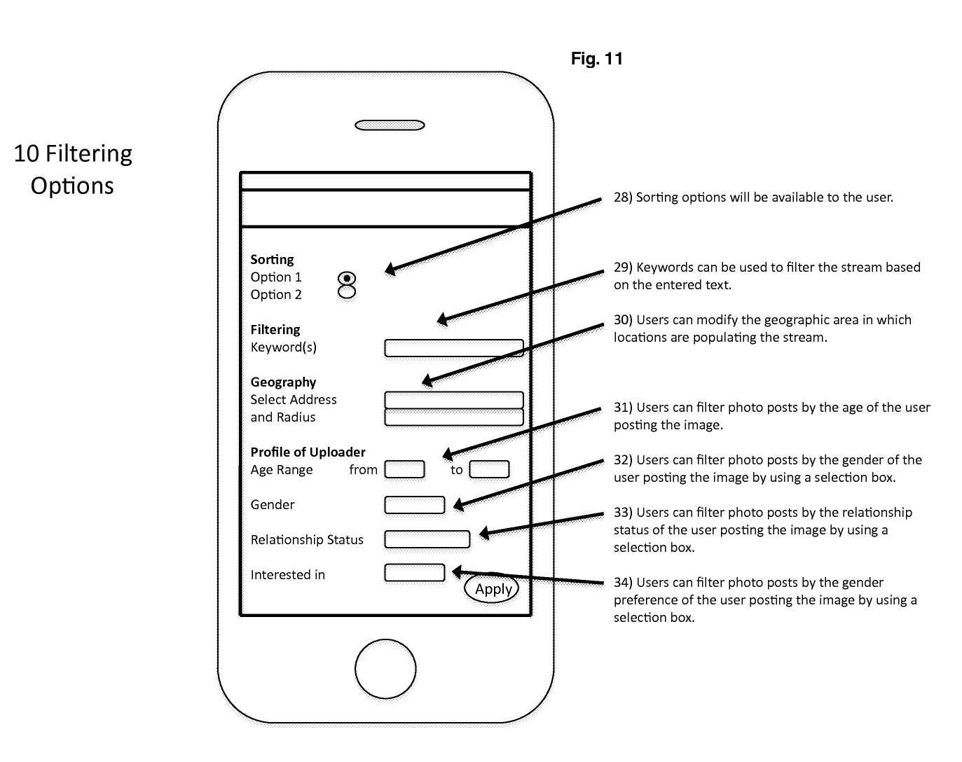

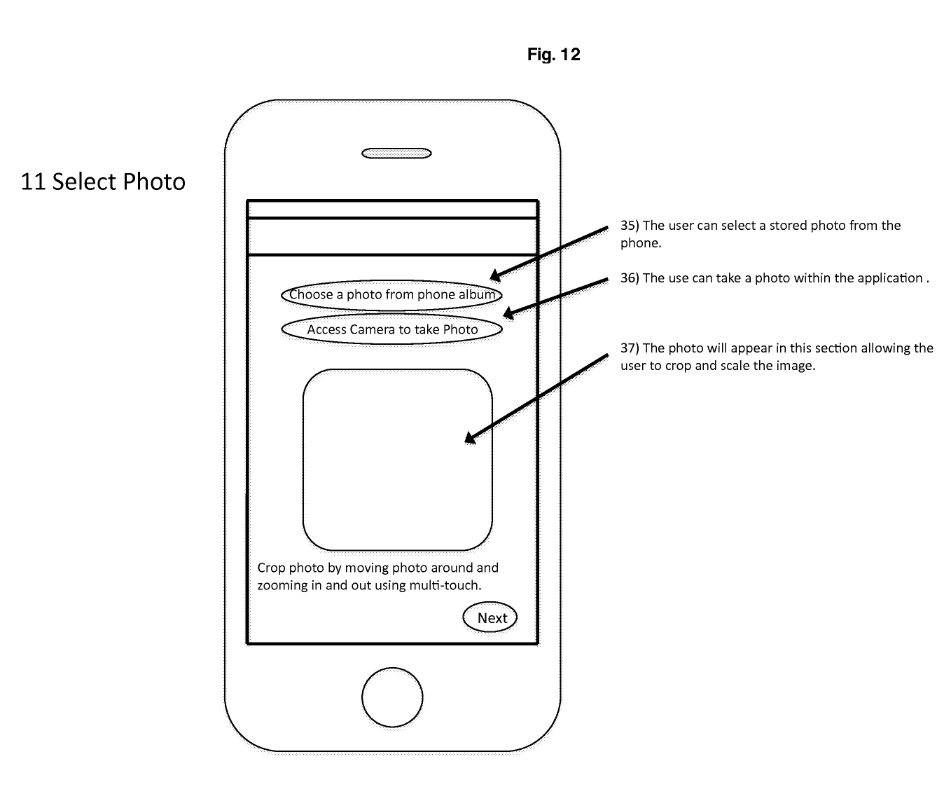

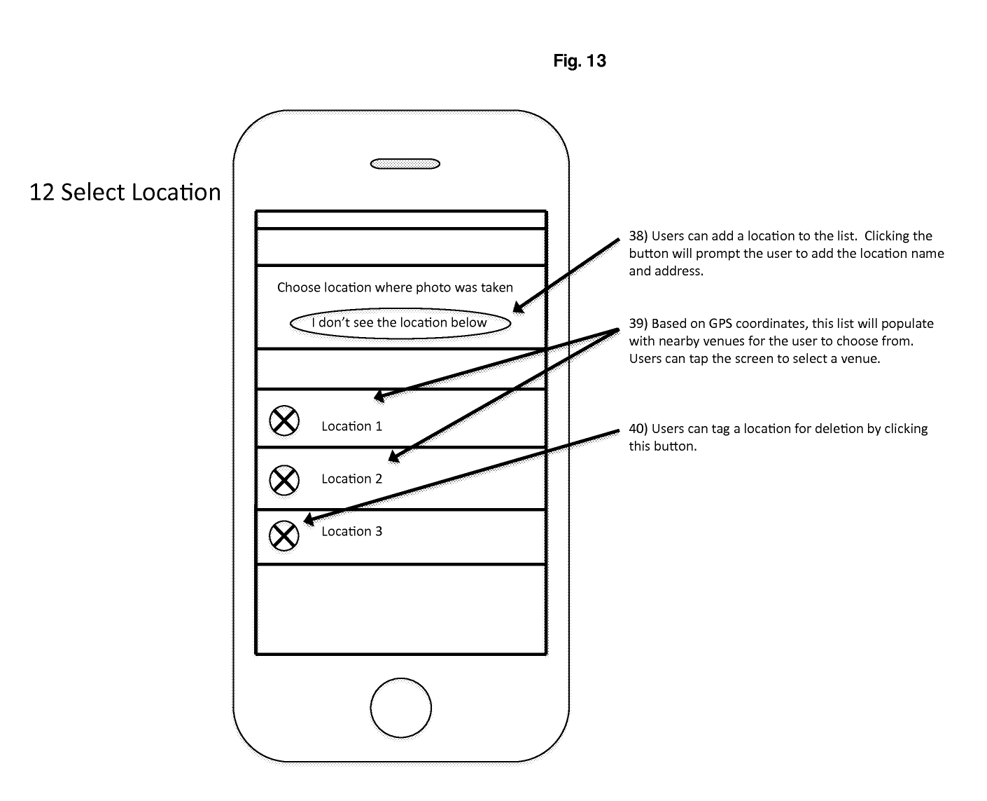

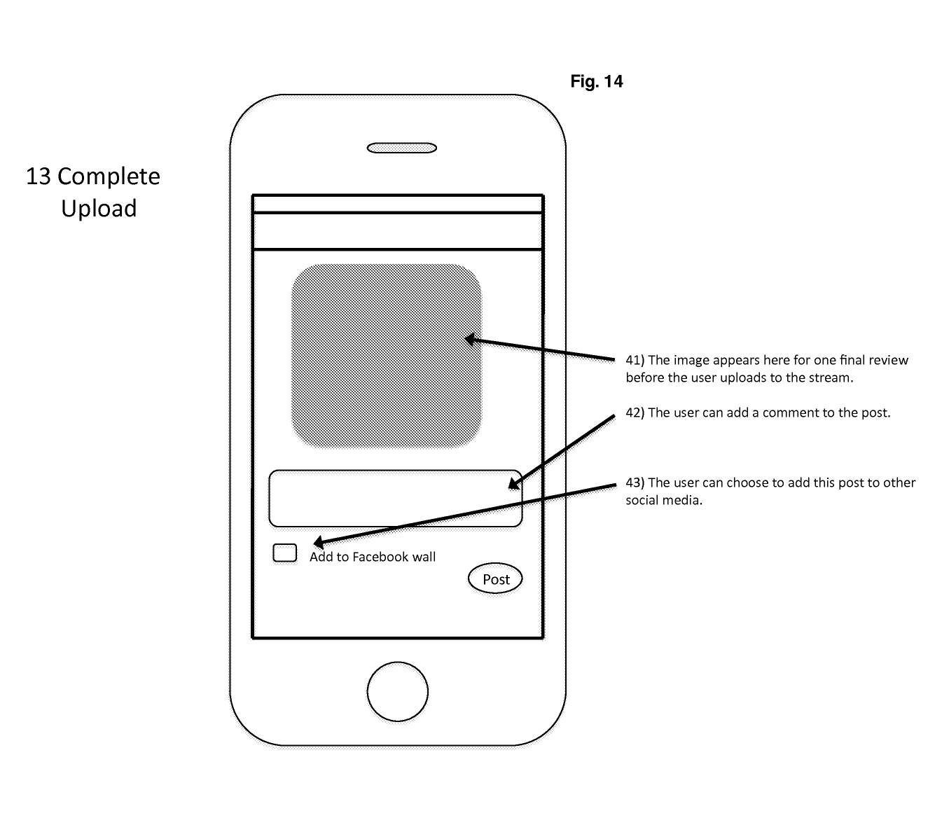

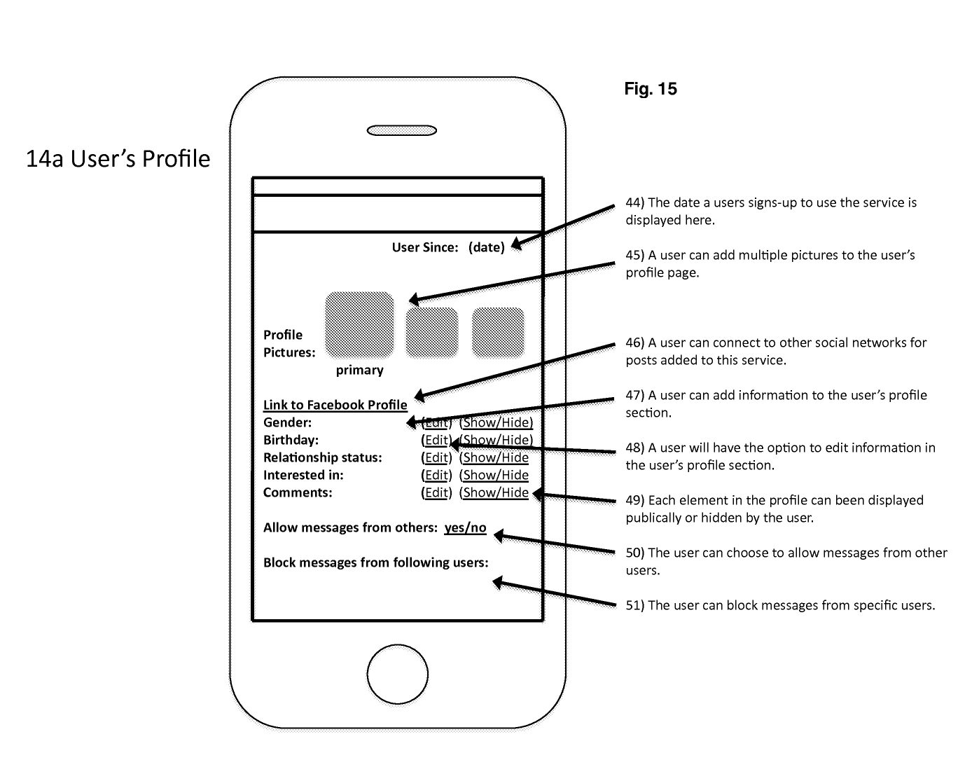

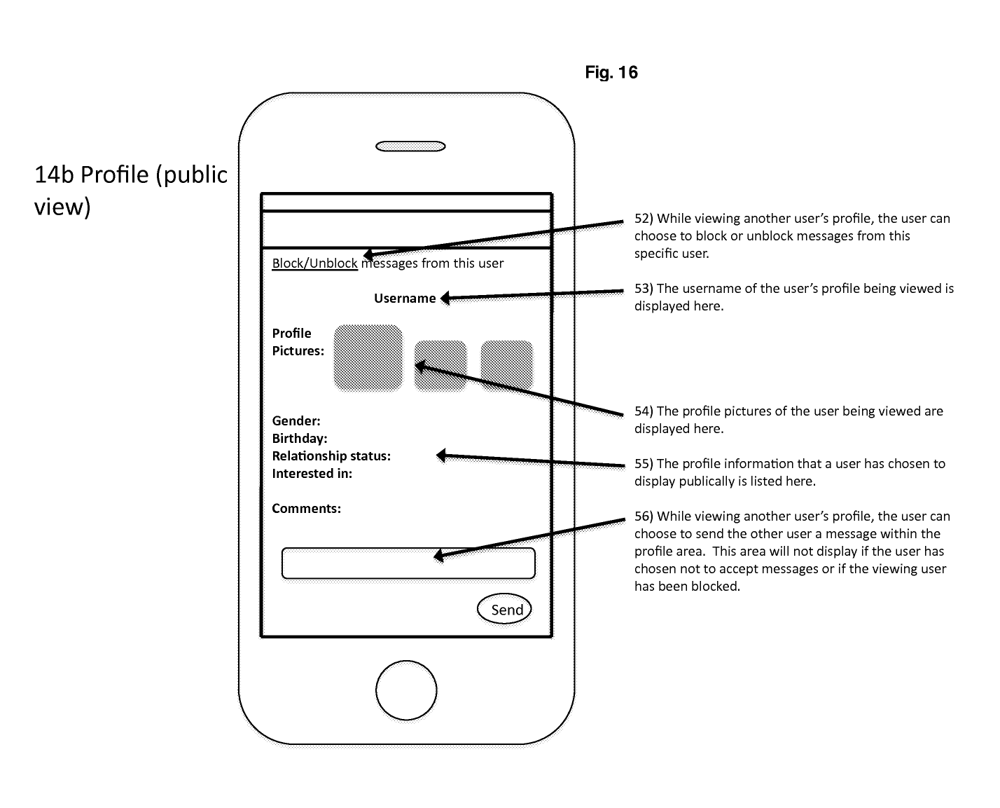

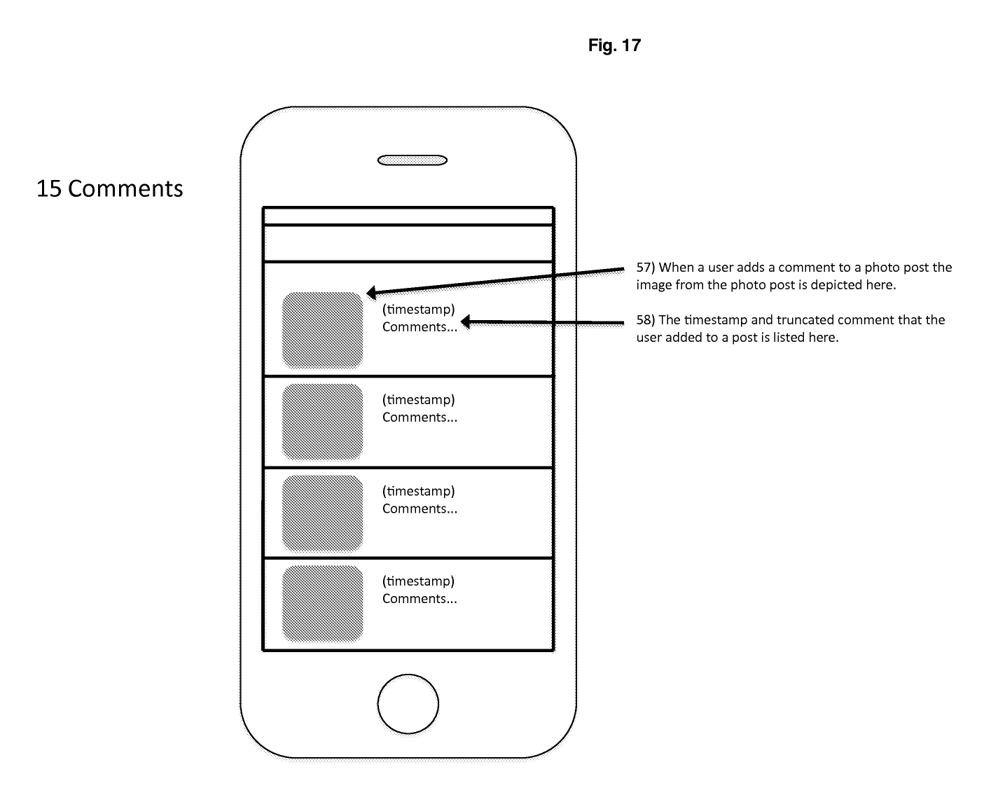

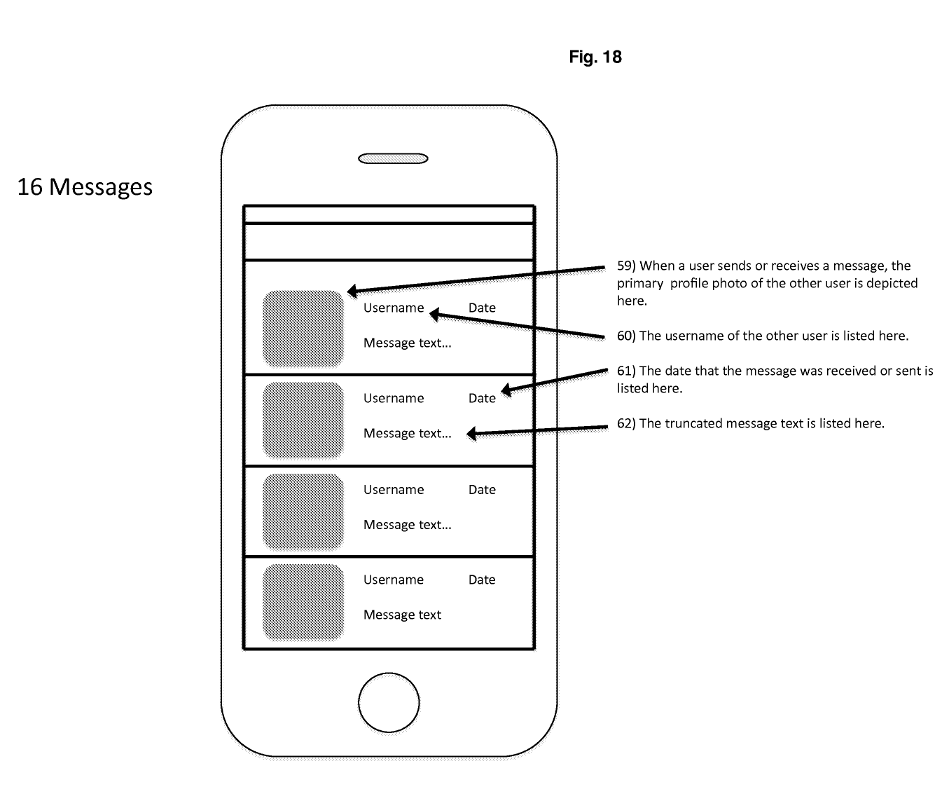

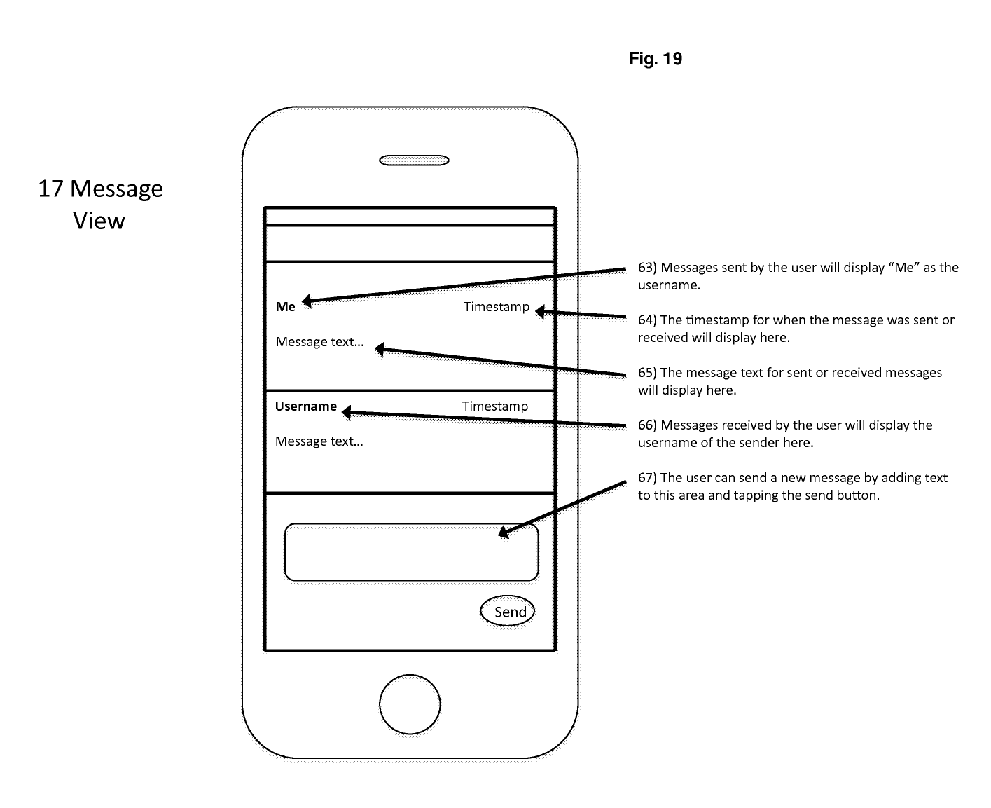

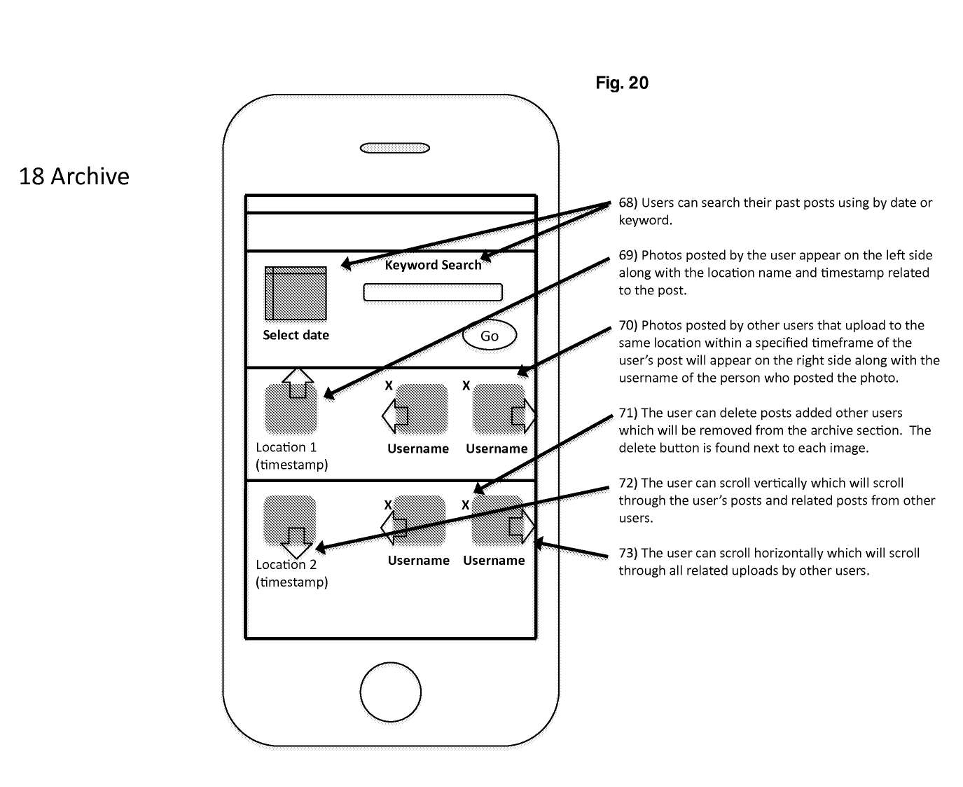

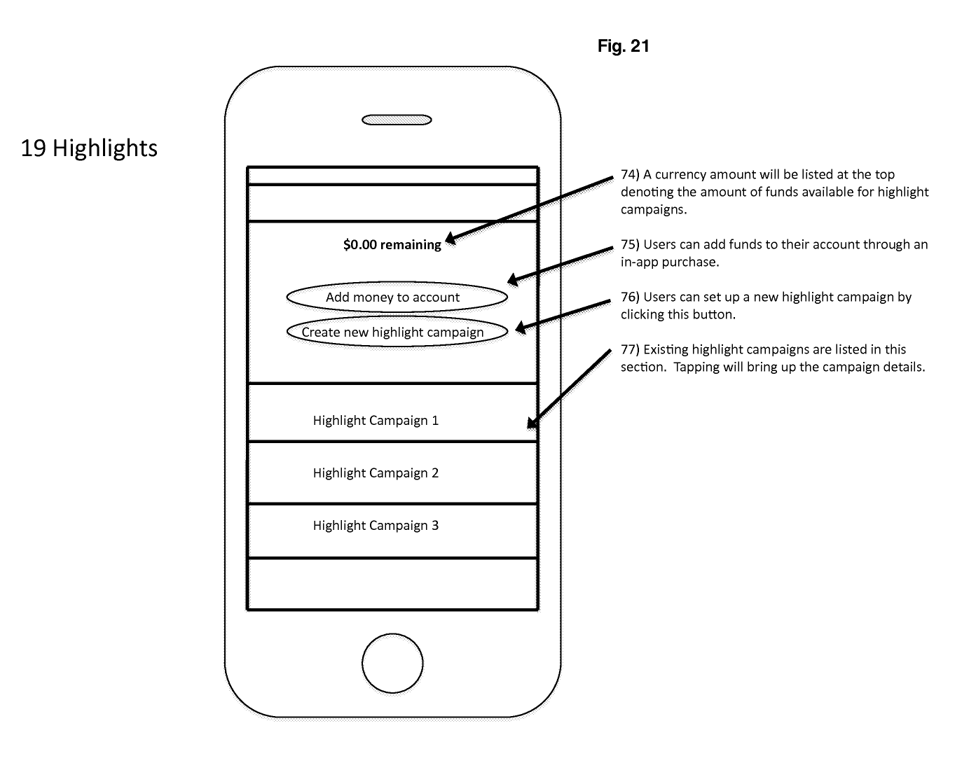

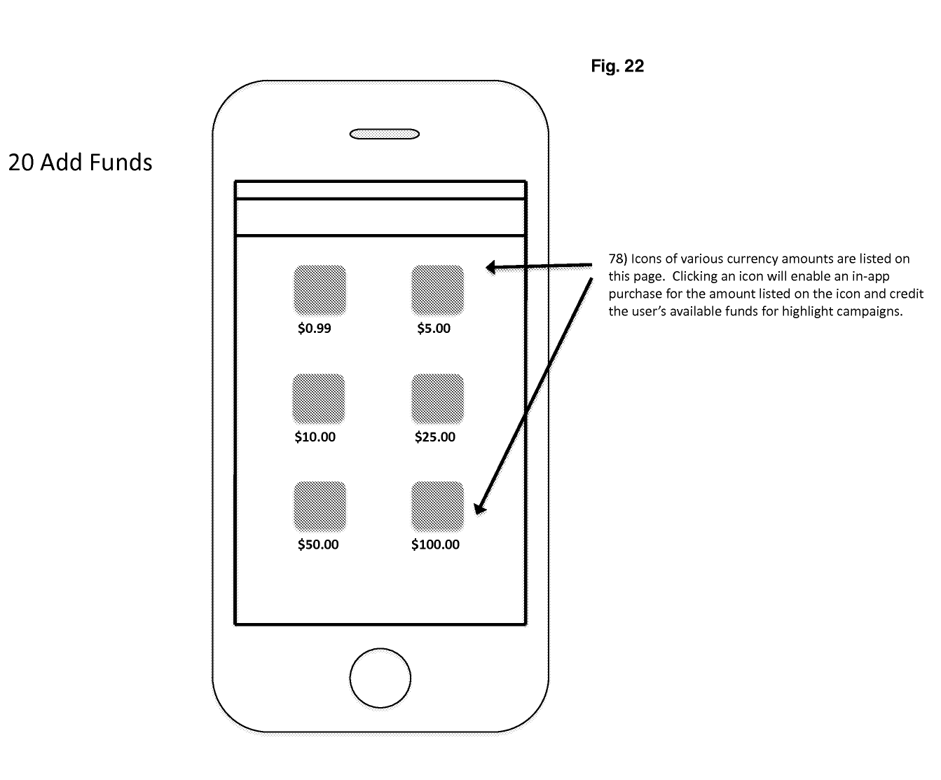

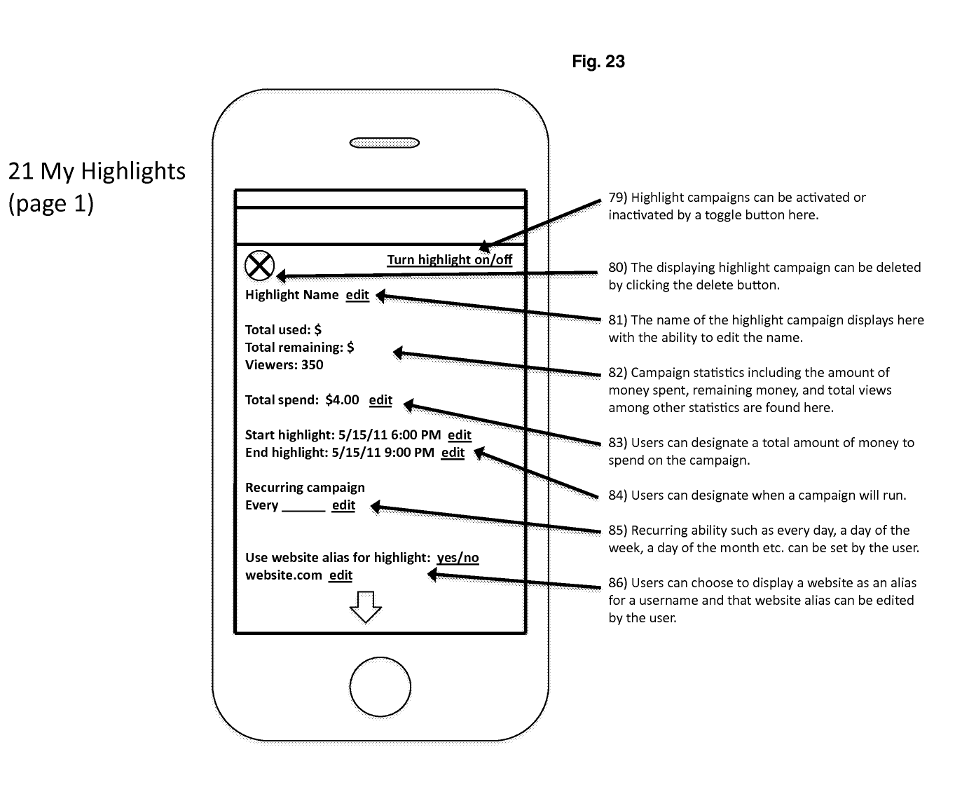

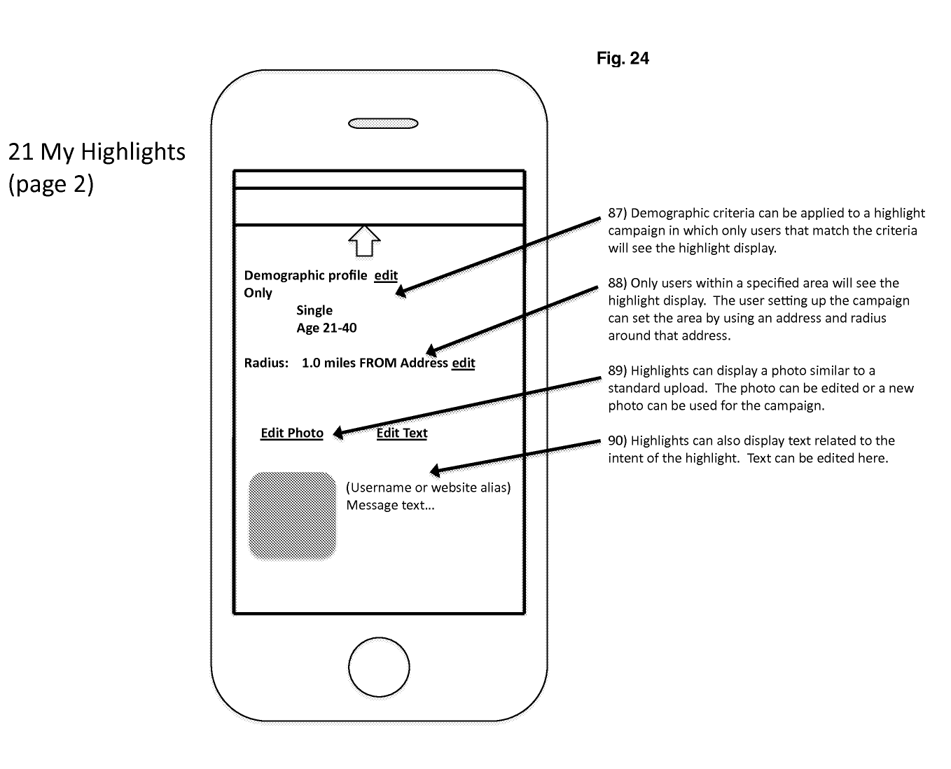

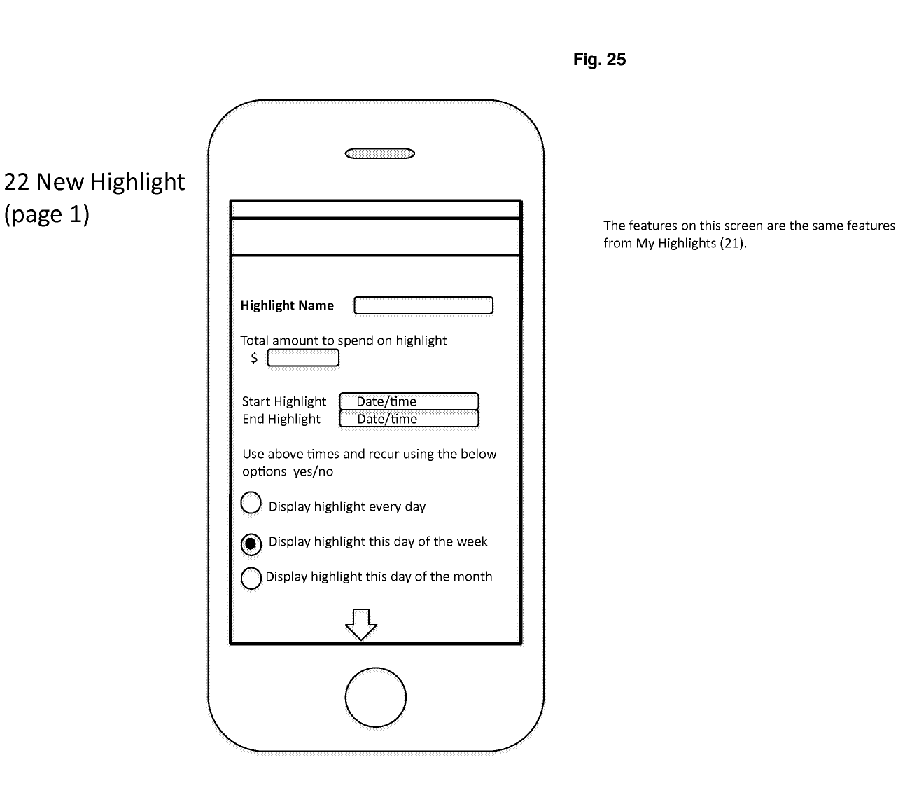

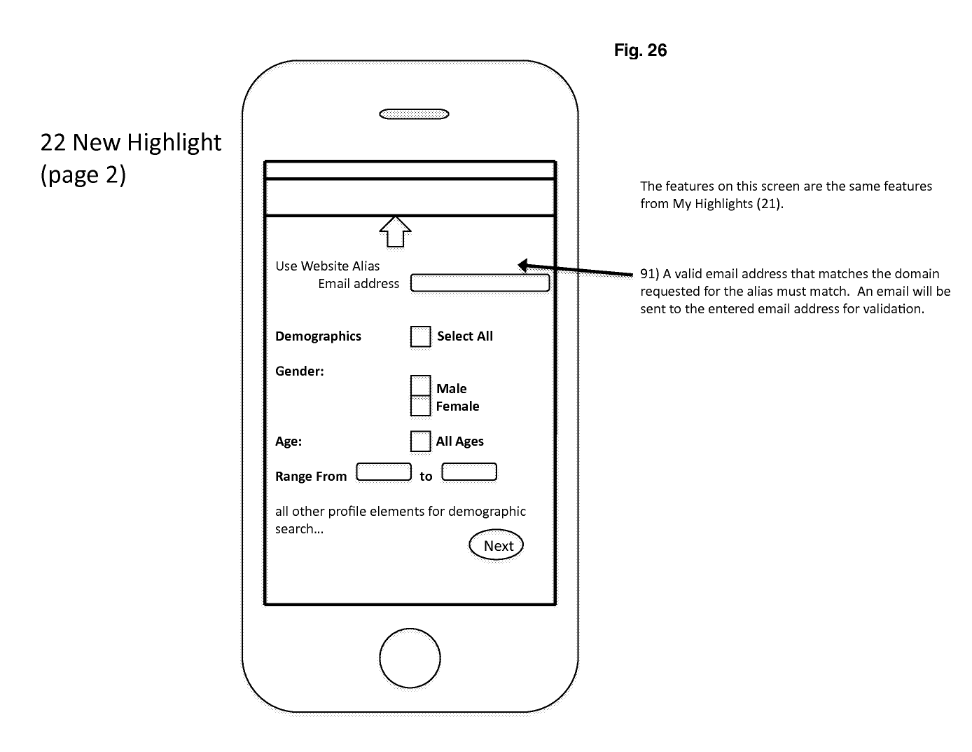

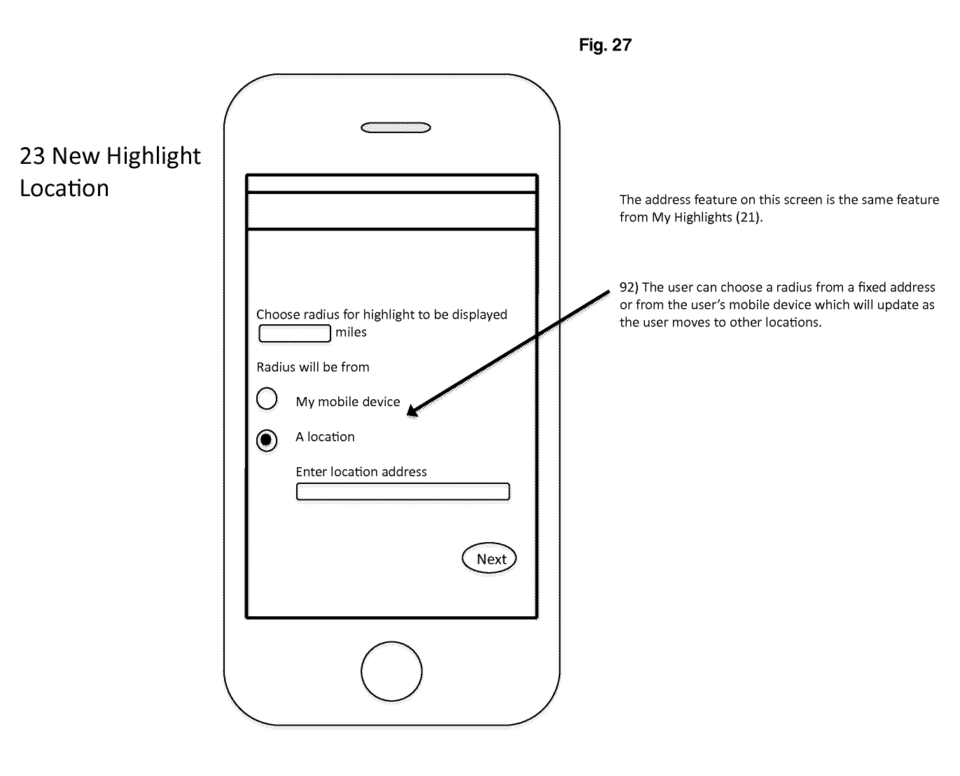

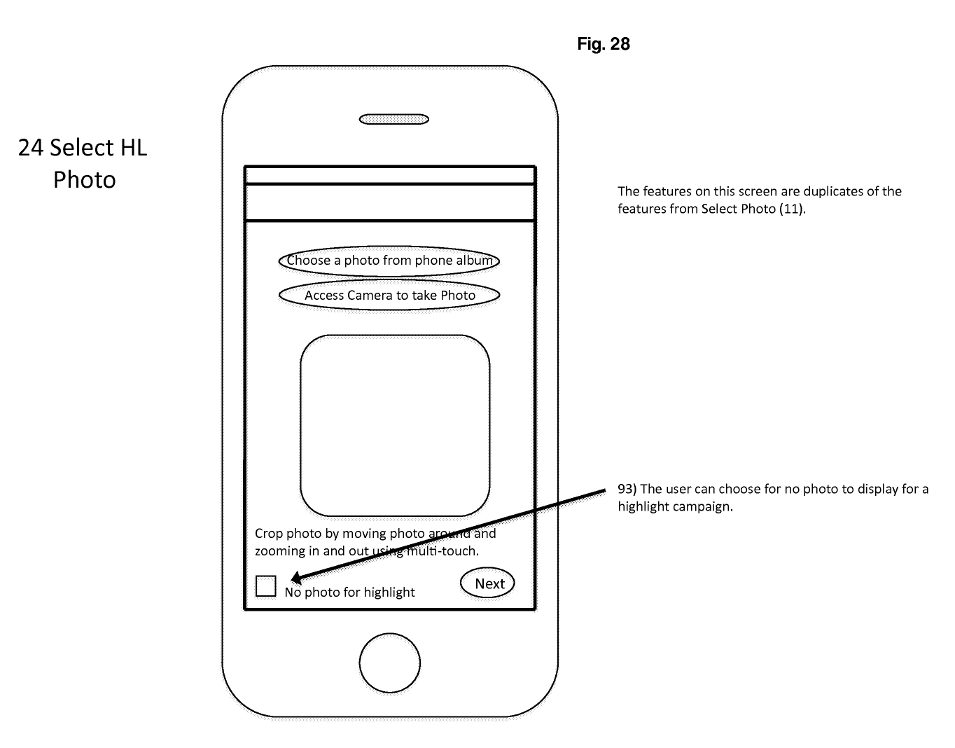

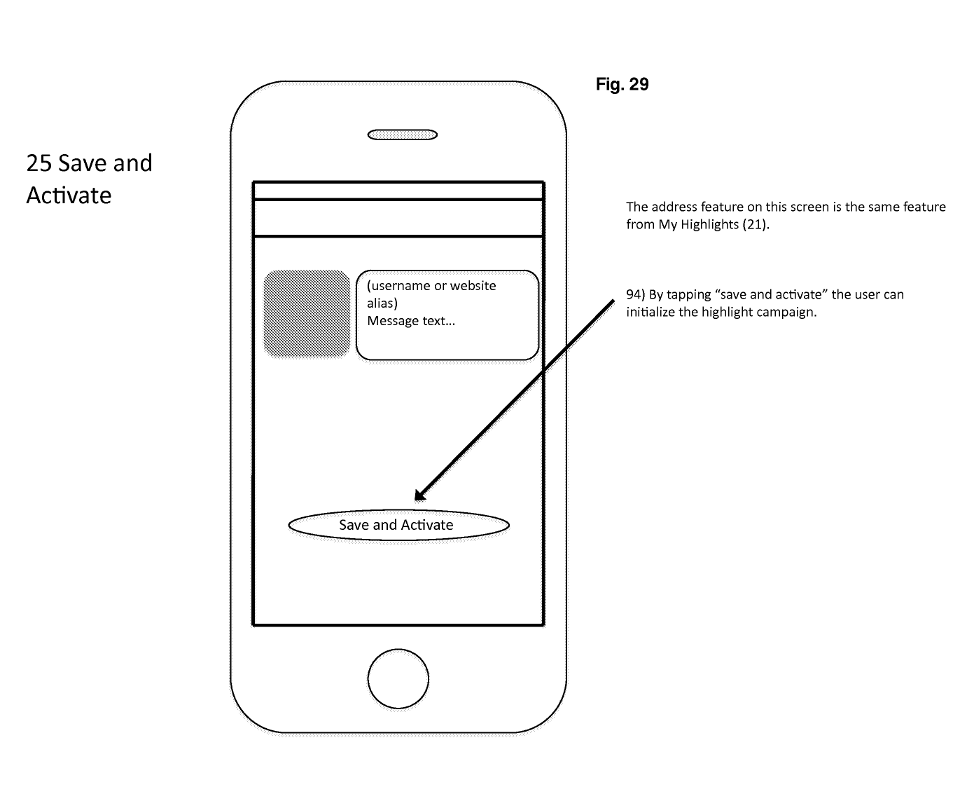

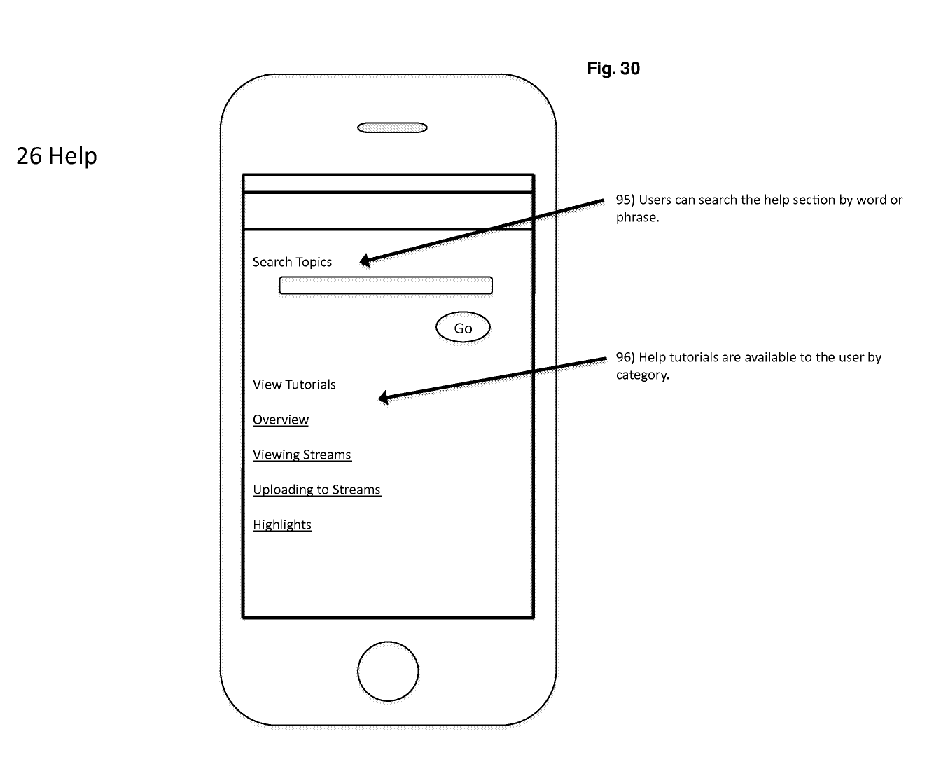

The invention may preferably be a multi-platform mobile application and website. In a preferred embodiment, databases will store content, which is retrieved via web services and displayed on either a website or on a mobile phone running the application. Since the mobile application will carry all of the features found on the website with additional features and functionality, only the mobile application's features will be listed in this section. The application schematic, with screens and views displayed within the invention, is depicted in FIG. 1.

A list of features listed numerically within the attached drawings include:

Login: Existing users can log into the application or website using a previously created username and password set by the user.

New user signup: New users can create an account. The new user will be prompted for a unique username and password. A dialogue box will appear notifying the user if a username is already provisioned and requiring the user to select a new username. Additionally, the user will enter an email address and other demographic information such as gender and birthday. Another dialogue box may appear if the user is not of a minimum age to use the application.

Home screen icons: The user can navigate the application by clicking labeled icons on the main screen.

New messages: A number will display above the Messages icon denoting the number of unread messages.

Log out: Users can log out of the application by clicking the Log Out button.

Change password: Users can change the log in password by clicking the Change password button, which will bring up a new page. On the new page the user must enter the existing password followed by the new password entered twice for validation.

Terms and conditions: Users can view the terms and conditions for using the application by clicking the button.

Stream select: Users will have three initial options for viewing the photo stream. Choosing “View places around me” will select locations from a pre-determined radius from the user's GPS location. The other options are “Select an area” and “My favorites.”

Select an area: A user can input an address and zip code, or simply a zip code, along with a radius to define a geographic area to view locations within the stream.

My favorites, groups: Sets of locations can be put into groups. Users can edit group names or click a button to view the stream, which will only contain the locations within the group.

My favorites, locations: Locations can be deleted from a group or moved to another group.

Location names: Location names are denoted above or below the photo thumbnails within the stream.

Location images: Photo thumbnails corresponding to locations are displayed in the stream.

Horizontal scrolling: Users can scroll horizontally between locations by swiping left or right over the location images.

Photo stack: The first location image in the stream can contain a stack of photos that correspond to that location.

Vertical scrolling: Users can scroll vertically over the photo stack, which will display the images in the stack.

Location details: The front photo in the photo stack will have details that display on the screen. These details include the timestamp for when the photo was uploaded, the username of the person who posted the image, and comments added by the posting user.

Options button: Clicking the options button will bring up a page with filtering options that can be applied to the stream.

Highlights: Highlights will display at the bottom of the screen below the stream. Highlights are discussed in more detail below.

Location information: The location name and address will be listed at the top of the screen.

Add location icon: Clicking the icon will allow the user to add the location to an existing group within the “My favorites” section or create a new group and add the location to the new group.

Username: The username of the person posting the photo is listed.

Enlarged image: The picture that displays is an enlarged version of the thumbnail from the stream.

Helpful buttons: Users can click on “Helpful” or “Not helpful” for any post. This data is collected and used within the sorting algorithm for the stream.

Report photo: Users can flag a photo as abusive by clicking the button. Flagged images may be deleted from the system.

Add comment: The user can add a comment to the comment thread.

Comment thread: Comments posted by other users are listed, in order by most recent first, within the comment thread.

Sorting options: Users can select between two algorithmic sorting options.

Keywords: A keyword or keywords can be used to filter the locations displaying within the stream.

Geography: Users can re-define the geographic area for displaying locations by typing in an address with corresponding radius.

Age filter: Users can apply an age filter that will only display stream photos that are posted by people that match the age parameters.

Gender filter: Users can apply a gender filter that will only display stream photos that are posted by people that match the gender parameter.

Relationship status filter: Users can apply a relationship status filter that will only display stream photos that are posted by people that match the selected status options.

Interested gender filter: Users can apply an interested gender filter that will only display stream photos that are posted by people that match the interested gender parameter.

Phone album: The mobile phone's photo album can be accessed to select a photo.

Access camera: The phone's camera can be accessed to take a picture within the application.

Crop photo: The selected photo from either the phone's album or a picture taken within the application will display. This photo can be scaled and cropped by using multi-touch.

Add location: Locations are be added to the database by users. Users will be prompted to enter the location name and address.

List of locations: A list of locations will populate based on the GPS coordinates of either the tagged photo or the phone's current position. This list will cover a pre-determined radius around the GPS coordinates.

Delete location: User's can delete a location. See (location editing method) for additional details.

Image review: The scaled and cropped image is displayed for a final review.

Photo comment: The user can add a comment related to the photo post.

Social media post: Users can simultaneously post the photo and comment to additional social media when posting to the application.

Sign up date: The date the user signed up for the service is displayed.

Profile pictures: Users can add several photos, which will display under the user's profile. The first photo will serve as the user's primary photo.

Social media connector: Users will be able to connect to other social media for simultaneous posting.

Profile information: A user can add information to their profile. This information includes, but is not limited to, gender, birthday, relationship status, interested in (gender), and comments.

Profile edit: Users can edit photos and profile information at any time.

Hide information: Users can show or hide profile information from the public.

Allow messages: Users have the option of allowing messages from other users or not allowing messages.

Blocked users list: The list of blocked users is listed. These blocked people cannot send messages to the user.

Block user: Clicking this toggle will block or unblock the person from being able to message the user and will be added to the blocked users list.

Profile username: The username of the profile being viewed is listed.

User photos: The thumbnail photos a user chooses to display publically are displayed at the top of the page.

User information: The profile information a user chooses to display publically is listed.

Send message: Messages can be sent to the user of the displayed profile if the user has allowed messages and the person sending the message is not on the user's blocked user list.

Comment photo: The photo from the post will display. Only posts that the user added a comment will display.

User's comment: Comments will only display in this section if the user had added to the thread. The comment and timestamp is listed.

Primary photo: The primary photo or a default system icon will display for users that have been messaged.

Message username: The username of the other user will display.

Message timestamp: The date and time of the message will display whether the message was sent or received.

Message text: The truncated message text will display.

First person username: If the user sent the message then the username will display as “me.”

Message timestamp: same as 61.

Full message: The full message text will display.

Message username: same as 60

New message: same as 56. However if the user has elected to not receive messages from users but has an active message string, then a message can still be sent.

Search posts: A user can search their past photo posts by either date range or keyword.

Thumbnail posts: The thumbnail post uploaded by the user is displayed along with the related location name and timestamp.

Other user thumbnail posts: Photos posted by other users that were uploaded to the same location within a specified timeframe of the user's post will appear on the right side along with the username of the person who posted the photo.

Delete related posts: The user can delete posts added other users, which will be removed from the archive section. The delete button is found next to each image.

User's posts vertical scroll: The user can scroll vertically which will scroll through the user's posts and related posts from other users.

Other users' posts horizontal scroll: The user can scroll horizontally which will scroll through all related photo posts by other users.

Available funds: A currency amount will be listed at the top denoting the amount of funds available for highlight campaigns.

Add money: Users can add money to their account through an in-app purchase. The in-app purchase transaction will occur within the mobile platform the person is utilizing. Generally, there will be a credit card on file in which the person will simply enter a password to authorize the financial transaction all within the application.

Set up new campaign: Clicking this button will allow the user to create a new highlight campaign.

Existing campaigns: Existing highlight campaigns are listed in which the user can simply scroll through the list and click to open the campaign details.

Add amount: Icons of various currency amounts are listed on this page. Clicking an icon will enable an in-app purchase for the amount listed on the icon and credit the user's available funds for highlight campaigns.

Toggle highlight activation: Highlights can be activated or inactivated by a toggle button.

Delete highlight campaign: Campaigns can be deleted by clicking the button.

Campaign name: The name of the highlight campaign is listed and the user at any point can edit that name.

Campaign statistics: Statistics related to an active highlight campaign are available to the user. The statistics include, but are not limited to, the amount of money spent, remaining money, and total views.

Total spend: The user can designate a ceiling limit for monetary spend within each individual highlight campaign.

Campaign times: The user can specify when a campaign will begin and end based on set days and times.

Recurring campaign: The user can have the campaign recur for each day, each week, or day of the month.

Alias: Users can set a website alias to display instead of the user's username.

Demographic filters: Various filters can be used to target the highlight campaign. All profile information elements can be used for targeting purposes.

Campaign area: A geographic area for displaying the highlight can be set. Only users within this area using the application will be able to see the highlight.

Highlight photo: The photo used for the campaign can be viewed or edited.

Highlight message: The text associated with the highlight can be viewed or edited.

Alias verification: For verification purposes the user will enter an email address associated with the website domain they wish to use as the alias. The system will then send an automated email to the email address for verification. Once verified the web address will display on the highlight.

Radius options: The highlight campaign can utilize a radius around a fixed address or from the GPS coordinates of the phone of the highlight creator's mobile phone.

No highlight photo: The user can create a text-only highlight.

Save and activate: The user can review the highlight as it will display on other user's screens. Clicking the button will initialize the campaign.

Help search: Words or phrases can be used to search help topics.

Help tutorials: Video and pictorial tutorials can be browsed.

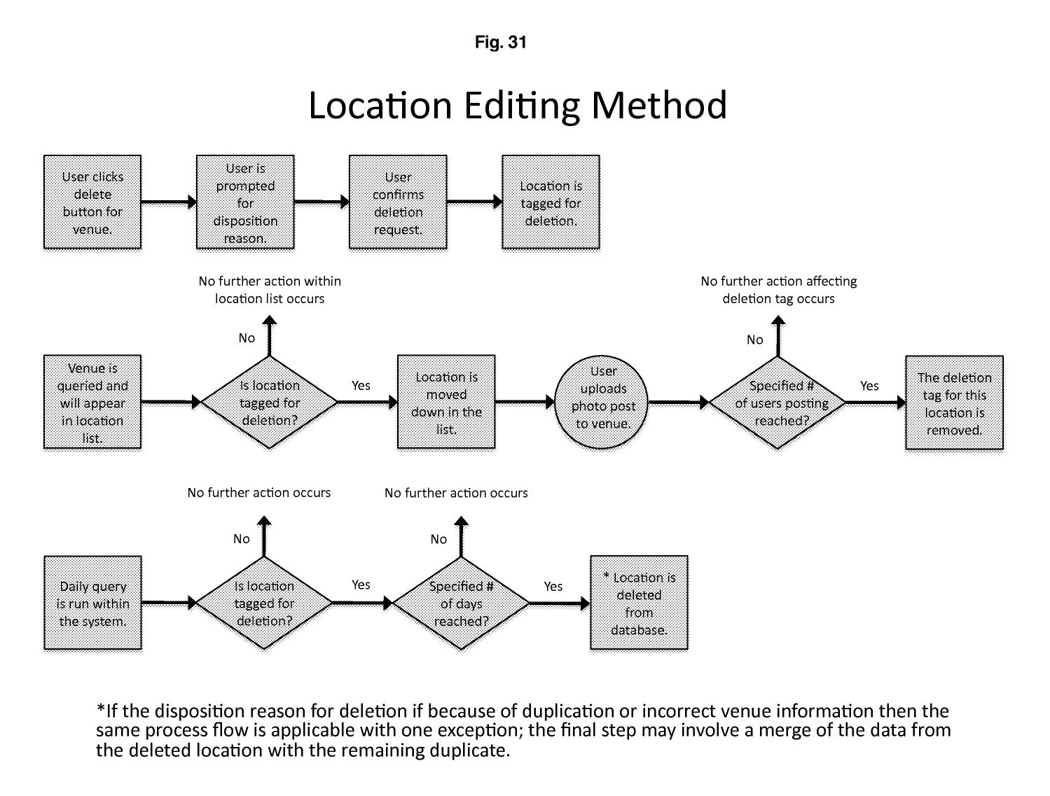

The location editing method (See FIG. 31) may utilize the following steps and rules:

Step 1) User selects button to delete a location.

Step 2) User is prompted for a disposition reason for the deletion, such as duplicate, out of business, incorrect venue information etc.

Step 3) The user will be prompted a final time to delete location. If the user confirms then the location will be tagged for deletion.

Locations tagged for deletion will follow the following rules:

Rule 1: The location will move down in the priority order on the list of locations that displays. For example, it may move down 15 slots in the list.

Rule 2: If a specified number of users upload to the location tagged for deletion within a specified timeframe, then the location's deletion tag is removed and it goes back into the original priority order.

Rule 3: If a location tagged for deletion does not get the specified number of users to upload to it within the specified timeframe, then the location is deleted from the system.

This methodology is utilizing inaction by users as a confirmation to the action as opposed to requiring action by others to confirm the deletion. Since users can create and delete venues, any editing of location information is handled by deletion of the current venue and then addition of the location with the corrected information.

Another benefit of the present disclosure may be Highlights. A person can select from various demographic elements and specify a geographic area for their ad to display. For example, Jan owns a wedding shop in downtown St Pete and has a sale on wedding dresses. She wants to get people to her store and so she sets up a Highlight campaign in Eyecrawler. She chooses a radius of half-a-mile around her store's address and additionally uses some demographic elements such as gender: female and relationship status: engaged. This means that ONLY engaged women using Eyecrawler within half-a-mile of the store's address will see the Highlight.

Highlights will rotate only when the stream is refreshed. This means that the same highlight ad will display on the screen as a person navigates through the photo stream. Essentially the system will run a query whenever the stream comes up or is refreshed. This query will identify the user's GPS coordinates and will pull a list of potential Highlights that meet the geographic and demographic criteria. Out of that potential list of Highlights one will display at random.

Highlights can consist of a picture with text or text alone.

The purchasing mechanism for Highlights is an in-app purchase. This means that a person doesn't have to put in any credit card information as their mobile platform e.g. The App Store for Apple or Android Market for Android etc. will already have their card on file. The person simply puts in their password and the card on file is billed.

A person can create multiple Highlight campaigns and designate when each one will be active. The system may also give recurring options so a person can create a Highlight and have it display every Wednesday for example. Once funds run out a user will need to buy more credits. If they are out of credits all active campaigns will suspend and the user will get a notification that their account is out of funds at which point they just repeat the in-app purchase described above.

The Highlights campaign can be further described in a preferred embodiment as follows. An advertiser creates the campaign, preferably via a smartphone or other mobile device. The advertiser may specify various parameters, such as demographics (age, gender, relationship status, etc.) to whom the advertisement should be directed. Because the system is designed in a preferred embodiment for mobile devices which are typically associated with a single person, a system in accordance with the present disclosure can specifically target a variety of demographic groups.

The advertiser may also select a geographic area in which the campaign is to be displayed. In a preferred embodiment, the advertiser selects an address or other geo-location information, and a radius around which the campaign should be active. This information may then preferably be stored in a server to be utilized for the system and method disclosed herein. Preferably, the information is stored in a database.

A user of the system and method will preferably access a stream on their mobile device. While the stream is loading, the mobile device may preferably send its geographic information to the server. This geographic information is preferably latitude and longitude coordinates, but any geographic or geo-locating information may be utilized. The server then queries its database to determine if the coordinates provided fall within the coordinates of any active Highlights campaigns. If so, the server further checks the user's demographic information to see if they match the demographic information associated with the campaign. In a preferred embodiment, the user has provided his or her demographic information in an initial or previous use of the mobile device so that the demographic information may be stored in the database. Alternatively, the mobile device may also communicate sufficient demographic information gathered from the mobile device when it communicates location information to the server. If there is a match for both location and demographics, the respective advertising campaign will be displayed. If there are multiple matches, a random campaign may display, or the campaigns may display sequentially.

Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for preparing an advertising campaign on a first mobile communication device for delivery to a second mobile communication device belonging to a specific demographic within a specific geographic area, the method comprising:
selecting via an interface on the first mobile communication device a financial amount to spend on the advertising campaign, wherein the financial amount is determined based upon the number of impressions in which the advertising campaign is to be viewed;
selecting via the interface on the first mobile communication device a time period during which the advertising campaign is to be active;
selecting via the interface on the first mobile communication device one or more demographic groups to whom the advertising campaign will be displayed;
selecting via the interface on the first mobile communication device one or more geographic areas in which to display the advertising campaign; and
displaying on an interface of the second mobile communication device the advertising campaign to a user within one of the demographic groups when the user's mobile communication device is located within one of the geographic areas.

2. A method for preparing an advertising campaign, the method comprising:
associating a demographic group with the advertising campaign;
associating a geographic area with the advertising campaign;
determining whether a mobile device is within the geographic area and whether the device is associated with the demographic group and if so, displaying the advertising campaign on the device.

3. The method of claim 2 wherein the device is a smartphone.

4. The method of claim 2 further comprising:
associating a time period during which the advertising campaign is active.

5. The method of claim 2 wherein associating a demographic group comprises:
associating via a mobile device a demographic group with the advertising campaign.

6. The method of claim 2 wherein the geographic area comprises an address and a radius.

7. The method of claim 6 wherein determining whether the mobile device is within the geographic area is performed by comparing the location of the second mobile device to the geographic area defined by a coordinate map generated by the address and the radius.

8. The method of claim 2 wherein determining whether the mobile device is within the geographic area is performed via a server.

9. The method of claim 8 wherein the server is a central server.

10. The method of claim 2 further comprising:
pre-registering a plurality of mobile devices to receive one or more advertising campaigns.

11. The method of claim 11 wherein pre-registering comprises:
associating demographic information with a mobile device.

12. The method of claim 11 wherein the demographic information is stored in a database.

13. An advertising system, the advertising system comprising:
a first processing unit configured to:
associate a demographic group with an advertising campaign;
associate a geographic area with the advertising campaign; and
a second processing unit configured to display the advertising campaign when the second processing unit is located with the geographic area associated with the advertising campaign and demographic information associated with the second processing unit corresponds to the demographic information associated with the advertising campaign.

14. The system of claim 13 wherein the first processing unit comprises a mobile processing unit.

15. The system of claim 12 wherein the first processing unit comprises a smartphone.

16. The system of claim 13 further comprising:
a central processing unit.

17. The system of claim 16 wherein the central processing unit is configured to store the association of a demographic group with an advertising campaign.

18. The system of claim 16 wherein the central processing unit is configured to determine when the second processing unit is located within the geographic area associated with the advertising campaign.

19. The system of claim 16 wherein the second processing unit is configured to determine when the second processing unit is within the geographic area associated with the advertising campaign.

20. The system of claim 13 wherein a demographic group comprises at least one of age information, gender information, and relationship information.
